(19) United States
(12) Patent Application Publication
(10) Pub. No.: US 2019/0226342 A1
(43) Pub. Date: Jul. 25, 2019

(54) Rotor, in particular blisk of a gas turbine, having a broken-up rim and method for producing the same

(71) Applicant: MTU Aero Engines AG, Muenchen (DE)

(72) Inventors: Werner HUMHAUSER, Moosburg (DE); Hermann KLINGELS, Dachau (DE)

(21) Appl. No.: 16/246,862

(22) Filed: Jan. 14, 2019

(30) Foreign Application Priority Data
Jan. 19, 2018 (DE) 102018200832.9

(51) Int. Cl. F01D 5/08

(52) U.S. Cl. CPC F01D 5/087; F05D 2220/32; F05D 2230/13; F05D 2260/221; F05D 2240/55; F05D 2240/24

(57) ABSTRACT

A rotor is provided, in particular a blisk of a gas turbine, including a rotor disk or a rotor ring and rotor blades disposed on a periphery of the rotor disk or rotor ring. At least one radial slot is provided in a peripheral surface of the rotor disk or rotor ring between two rotor blades, which radial slot opens into a rounded opening extending between axial end faces of the rotor disk or rotor ring. A method for manufacturing the rotor is also provided.

This claims the benefit of German Patent Applicatin DE 102018200832.9, filed Jan. 19, 2018 and hereby incorporated by reference herein.

The present invention relates to a rotor, in particular a blisk of a gas turbine, and to a method for producing the same.

In a blisk (integrally bladed disk), rotor blades and a rotor disk are built as a single piece. Blisks are used in particular in gas turbines and turbine engines. Blisks are typically made from forging materials which can be thermally loaded only to a limited extent. Therefore, in such turbine engines, elevated high-pressure compressor exit temperatures are a challenge for a blisk. At the same time, the blisk design is intended to improve the weight and efficiency of the compressor. In order to maintain the thermo-mechanical fatigue of the aft rotor stage constant despite the elevated temperatures, cooling air should be injected in the region of the aft cone and should flow around the last rotor stage or cool the cavity under the last stator vane. This is not possible with a conventional blisk design.

In engines with cooling air injection and high compressor exit temperatures, an axial or circumferential groove is used in the last high-pressure compressor stage to conduct cooling air through the groove base into the disk region and to the upstream compressor stage on the one hand, and, on the other hand, to obtain a structure that is broken up in the circumferential direction in the region of high heat transfer rates from the annular space toward the blade base to thereby reduce large variations between tensile and compressive stresses during load changes. DE 10 2009 021 384 A1, for example, discloses a gas turbine in which a cooling air stream is introduced into cavities.

U.S. Pat. No. 8,727,695 B2 discloses a rotor having a bladed rotor ring. Disposed adjacent the rotor ring is a spacer having a plurality of grooves formed in the outer peripheral surface thereof.

WO 2015 092 306 A1 discloses a rotor including a bladed rotor ring, where a plurality of ribs are provided on an outer peripheral surface of the rotor ring between rotor blades.

DE 10 2006 061 448 B4 discloses a blisk including a rotor disk and integrated rotor blades. The rotor disc has rectangular cutouts formed therein by electrical discharge machining.

### SUMMARY OF THE INVENTION

It is an object of the present invention to improve a rotor, in particular a blisk, and its manufacturing method.

The present invention provides a rotor, in particular a blisk of a gas turbine, having a rotor disk or a rotor ring and rotor blades disposed on a periphery of the rotor disk or rotor ring. A radial slot is provided in a peripheral surface of the rotor disk or rotor ring between at least two rotor blades, which radial slot opens into a rounded opening extending between axial end faces of the rotor disk or rotor ring.

Advantageously, by using the rotor configured as described above, it is possible to increase the lifetime thereof by cooling and reducing stresses, given an identical thermodynamic cycle; i.e., for example, given the same overall pressure ratio (OPR) or given the same compressor exit temperature, or to increase the rotational speed so as to increase the efficiency of the compressor. It is also possible to increase the overall pressure ratio (OPR) or the compressor exit temperature to improve the thermodynamic cycle of the engine.

Preferably, the rounded opening is at least substantially edgeless, in particular round or elliptical, in configuration to minimize stress peaks in the circumferential direction as well as the stress concentration effect.

Preferably, the rotor blades are inclined relative to a rotor axis at a first angle in their blade base, and the radial slot has a second angle relative to the rotor axis in the peripheral surface of the rotor disk or rotor ring, the second angle being smaller than the first angle. This makes it possible to prevent the radial slot from intersecting the blade base.

Preferably, the angle of the radial slot relative to the rotor axis decreases as it approaches the opening. At the transition into the opening, the angle of the radial slot relative to the rotor axis may, in particular, be substantially equal to the axis angle of the opening. This allows the radial slot to be optimally aligned with an axis of the opening, thus enabling even better suppression of stress peaks.

Preferably, the rotor has an insert which is provided in the opening and has an axially extending passage therethrough. This makes it possible to optionally inject cooling air into the respective upstream compressor stage. If the insert has no such passage, it serves as a seal for substantially closing or sealing the opening.

Further preferably, the insert has some radial play within the opening and is configured to be moved relative to the rotor disk or rotor ring by centrifugal force during rotation of the rotor. Because of this, the insert functions as a damper to dampen a torsional oscillation superimposed on the rotational speed.

Another aspect of the present invention relates to a method for manufacturing a rotor, in particular a blisk of a gas turbine, by which method the same advantages can be achieved.

Preferably, the radial slot is formed by wire electrical discharge machining or wire cutting and/or the opening is formed by drilling. The rotor is preferably forged. After the insert is inserted into the opening, one end thereof is preferably flanged or expanded. This allows the rotor to be easily manufactured at low cost.

### BRIEF DESCRIPTION OF THE DRAWINGS

Further advantageous refinements of the present invention will become apparent from the dependent claims and the following description of preferred embodiments. To this end, the drawing shows, partly in schematic form, in:

FIG. 1: a partial front view of a rotor according to an embodiment of the present invention;

FIG. 2: a cross-sectional view taken along section line A-A in FIG. 1;

FIG. 3: a partial plan view of the rotor according to an embodiment of the present invention;

FIG. 4A: a longitudinal sectional view of an insert in the inserted state; and

FIG. 4B: a longitudinal sectional view of the insert prior to insertion.

### DETAILED DESCRIPTION

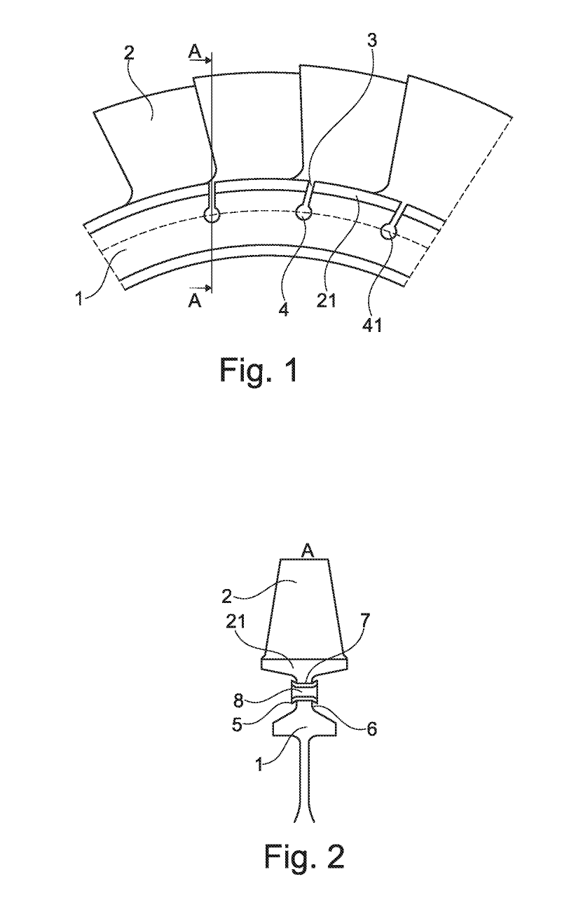

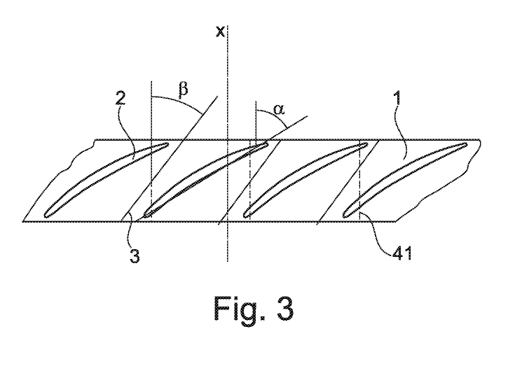

FIG. 1 shows a partial front view of a rotor according to an embodiment of the present invention; FIG. 2 shows a cross-sectional view taken along section line A-A in FIG. 1; and FIG. 3 shows a partial plan view of the rotor according to an embodiment of the present invention.

The rotor takes the form of a blisk of a gas turbine and includes a rotor ring 1 having integrated rotor blades 2 disposed on a periphery of rotor ring 1. Alternatively, a rotor disk may be used instead of rotor ring 1, the ratio of the outer circumference of the rotor disk to the inner bore being larger than in the case of rotor ring 1.

At least one radial slot 3 is provided between two rotor blades 2 in an outer peripheral surface of the rotor disk or rotor ring 1; i.e., in the blade base or in what is referred to as the disk rim, which radial slot opens into a rounded opening 4 extending between axial end faces 5, 6 of the rotor disk or rotor ring 1. A diameter or width of opening 4 is equal to or greater than a width of radial slot 3. Radial slot 3 may be formed, for example, by wire electrical discharge machining. The radial slot extends completely through between the axial end faces 5, 6 of rotor-ring 1.

In the exemplary embodiment shown, a radial slot 3 is provided between each two adjacent rotor blades 2. In the illustrated rotor, the number of radial slots 3 is equal to the number of rotor blades 2. However, the present invention is not limited thereto and may use a greater or lesser number of radial slots 3 in the rotor. For example, more than one radial slot 3 may be provided between two adjacent rotor blades 2, or certain rotor blades 2 provided on the rotor may not have a radial slot 3 therebetween. The ratio of the number of radial slots 3 to the number of rotor blades 2 on the rotor may be, for example, 1/2, 1/3, 2/1 or 3/1.

Below the rim, radial slot 3 opens into opening 4, which in plan view may be a round bore, an ellipse or a different rounded opening, such as a hole with an open perimeter.

Opening 4 constitutes a rounded outlet of radial slot 3. Opening 4 is substantially edgeless. A width of radial slot 3 is not greater than a diameter or width of opening 4. This allows stress peaks to be reduced, because circumferential stresses are avoided or shifted to the region of openings 4, which now can be exposed to a flow of cooling air therearound. This also minimizes the stress concentration effect. Breaking up the peripheral surface of rotor ring 1 in the hot rim region by radial slots 3 not only reduces the high stresses, but additionally allows cooling air to be conveyed through radial slots 3 and, as the case may be, through openings 4 into the cavities of the respective upstream stage. In this way, an additional cooling effect may be achieved.

As shown in FIG. 3, rotor blades 2 are inclined relative to a rotor axis x at a first angle α in their blade base 21. Radial slot 3 has a second angle β relative to rotor axis x in the peripheral surface of rotor ring 1, the second angle being smaller than first angle α. This ensures that radial slots 3 do not intersect rotor blades 2 in the outer peripheral surface of rotor ring 1, i.e. in blade base 21.

The angle of radial slot 3 relative to rotor axis x decreases as it approaches opening 4 in the depth direction. At the transition into opening 4, the angle of radial slot 3 relative to rotor axis x is substantially equal to an axis angle of opening 4; i.e., radial slot 3 extends parallel to an axis 41 of opening 4 there. As regards manufacture, radial slot 3 may be formed by placing a tensioned electrical discharge machining wire at the second angle β on the peripheral surface of rotor ring 1 and then driving it radially into rotor ring 1 at a decreasing angle until it reaches the axially extending opening 4.

FIG. 2 shows an insert 7 which is provided in opening 4 and has an axially extending passage 8 therethrough. Cooling air flows through rotor ring 1 via passage 8, for example, to the respective upward compressor stage. An inner diameter of passage 8 is adapted to allow the desired throughput of air.

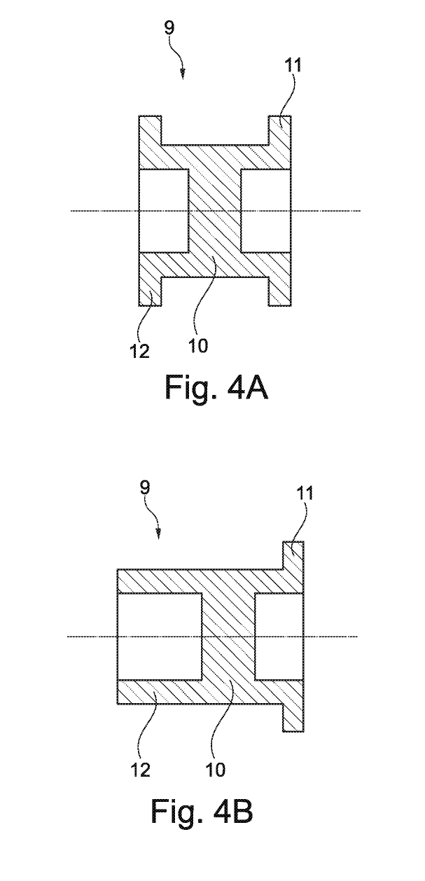

FIG. 4a shows a different insert 9 which is provided in opening 4 and substantially closes opening 4. In this manner, opening 4 is sealed. Insert 9 has a cylindrical main body having a first flange 11 and a second flange 12 at its axial end faces, the outside diameters of the flanges each being greater than that of the cylindrical main body. Insert 9 has a wall 10 formed at about the axial middle thereof, the wall preventing flow through insert 9. Insert 7 may be similar in configuration to insert 9, but has the passage 8 in place of wall 10.

Insert 7, 9 may have some radial play within opening 4 and be configured to be moved relative to the rotor disk or rotor ring 1 by centrifugal force during rotation of the rotor. As a result, insert 7, 9 functions as a damper and may dampen, for example, a torsional oscillation superimposed on the rotational speed.

Advantageously, by using the rotor configured as described above, it is possible to increase the lifetime thereof by cooling and reducing stresses, given an identical thermodynamic cycle; i.e., for example, given the same overall pressure ratio (OPR) or given the same compressor exit temperature, or, in cases where the concept definition is still open, to increase the rotational speed so as to increase the efficiency of the compressor. It is also possible to increase the overall pressure ratio (OPR) or the compressor exit temperature to improve the thermodynamic cycle of the engine.

The following is a description of a method for manufacturing the rotor.

First, the basic structure of the rotor, for example a blisk of a gas turbine, is provided, the basis structure including rotor ring 1 and rotor blades 2 disposed on the periphery of rotor ring 1. In the blisk, rotor ring 1 and rotor blades 2 are integrated. Such a basic rotor structure can be obtained by forging, for example.

At least one rounded opening 4 is formed between axial end faces 5, 6 of rotor-ring 1, for example by drilling.

Radial slot 3 is formed in the peripheral surface of rotor ring 1 between two rotor blades 2 in such a way that radial slot 3 opens into opening 4. This may be accomplished by wire electrical discharge machining or by wire cutting. In the process, a tensioned electrical discharge machining wire may be placed at the second angle β on the peripheral surface of rotor ring 1 and then be driven radially into rotor ring at a decreasing angle until it reaches the axially extending opening 4. A width of the electrical discharge machining wire, and thus of radial slot 3, is selected to be equal to or smaller than a diameter or width of opening 4.

After openings 4 are formed, inserts 7, 9 can be inserted or pressed into openings 4. FIG. 4A shows insert 9 in its shape after insertion into opening 4, and FIG. 4B shows insert 9 in its original shape prior to insertion into opening 4. In FIG. 4B, second flange 12 has not yet been formed. When in this shape, insert 9 can be inserted into opening 4 until first flange 11 rests against one of axial end faces 5, 6 or rotor ring 1. The opposite end of insert 9 is then flanged or expanded, so that the shape with second flange 12, shown in FIG. 4A, is obtained. The not yet inserted inserts 7, 9 may take the form of metal sleeves, metal tubes or rivets.

Insert 7 may be similar in configuration to insert 9, but has the passage 8 in place of wall 10. In a rotor, both inserts 7 having a passage 8 and inserts 9 having a wall 10 may be used in combination.

In a refinement of the present invention, the transition between radial slot 3 and opening 4 may be rounded in order to even further minimize stress peaks and the stress concentration effect.

While exemplary embodiments have been presented in the foregoing description, it should be understood that many variations are possible. It should also be appreciated that the exemplary embodiments are only examples, and are not intended to limit the scope, applicability, or configuration in any way. Rather, the foregoing detailed description provides those skilled in the art with a convenient road map for implementing at least one exemplary embodiment, it being understood that various changes may be made in the function and arrangement of elements described without departing from the scope of protection as derived from the claims and the combinations of features equivalent thereto.

### LIST OF REFERENCE NUMERALS

1 rotor ring
2 rotor blade
3 radial slot
4 opening
5 axial end face
6 axial end face
7 insert
8 passage
9 insert
10 wall
11 first flange
12 second flange
41 axis of the opening
x rotor axis
α first angle
β second angle

1-11. (canceled)

12. A rotor comprising:
a rotor disk or a rotor ring; and
rotor blades disposed on a periphery of the rotor disk or rotor ring, at least one radial slot being provided in a peripheral surface of the rotor disk or rotor ring between at least two of the rotor blades, the radial slot opening into a rounded opening extending between axial end faces of the rotor disk or rotor ring.

13. The rotor as recited in claim 12 wherein the rounded opening is edgeless in configuration.

14. The rotor as recited in claim 13 wherein the edgeless rounded opening is round or elliptical.

15. The rotor as recited in claim 12 wherein the rotor blades are inclined relative to a rotor axis at a first angle in a blade base; the radial slot having a second angle relative to the rotor axis in the peripheral surface of the rotor disk or rotor ring, the second angle being smaller than the first angle.

16. The rotor as recited in claim 12 wherein an angle of the radial slot relative to the rotor axis decreases as the radial slot approaches the opening.

17. The rotor as recited in claim 12 further comprising an insert in the opening, the insert having an axially extending passage therethrough.

18. The rotor as recited in claim 17 wherein the insert has radial play within the opening and is configured to be moved relative to the rotor disk or rotor ring by centrifugal force during rotation of the rotor.

19. The rotor as recited in claim 12 further comprising an insert in the opening, the insert closing the opening.

20. The rotor as recited in claim 19 wherein the insert has radial play within the opening and is configured to be moved relative to the rotor disk or rotor ring by centrifugal force during rotation of the rotor.

21. A blisk of a gas turbine comprising the rotor as recited in claim 12.

22. A method for manufacturing a rotor including a rotor disk or a rotor ring and rotor blades disposed on a periphery of the rotor disk or rotor ring, the method comprising the following steps:
manufacturing a basic rotor structure including the rotor disk or rotor ring and the rotor blades;
forming an opening between axial end faces of the rotor disk or rotor ring; and
forming a radial slot in a peripheral surface of the rotor disk or rotor ring between at least two rotor blades in such a way that the radial slot opens into the opening.

23. The method as recited in claim 22 wherein the rotor is forged or the radial slot is formed by wire electrical discharge machining or wire cutting or laser cutting or the opening is formed by drilling.

24. The method as recited in claim 22 further comprising inserting an insert into the opening.

25. The method as recited in claim 24 wherein, after the insert is inserted into the opening, one end of the insert is flanged or expanded.

26. The method as recited in claim 22 wherein the rotor is a blisk of a gas turbine.
